(19) United States
(12) Patent Application Publication
(10) Pub. No.: US 2011/0037896 A1
(43) Pub. Date: Feb. 17, 2011

(54) Electronic Device and Method for Simultaneously Displaying Widget Window and Video Signal in Display Device

(76) Inventors: Yung-Chih Lin, Taipei Hsien (TW); Po-Hsu Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/844,846

(22) Filed: Jul. 28, 2010

(30) Foreign Application Priority Data
Aug. 13, 2009 (TW) 098127243

(51) Int. Cl. H04N 5/445; G09G 5/00

(52) U.S. Cl. 348/564; 345/634; 348/E05.104

(57) ABSTRACT

An electronic device for simultaneously displaying a widget window and a video signal in a display device includes a dividing unit for dividing a display area of the display device into a major display area and a minor display area, a first display unit for scaling the video signal to completely display the video signal in the major display area, and a second display unit for displaying the widget window in the minor display area.

### BACKGROUND OF THE INVENTION

1. Field of the Invention

The present invention is related to an electronic device and method for simultaneously displaying a widget window and a video signal in a display device, and more particularly, to an electronic device and method capable of completely displaying the video signal by dividing a display area of the display device.

2. Description of the Prior Art

With advances in technology, household appliances in function are approaching information technology products. For example, televisions (TVs) can display an intelligent tool window called a widget, which previously was employed only in information technology products like personal computers. In addition to traditional functions included in an operating system, such as software calculators, mini clocks, etc., the widget can further be utilized for displaying real time information, such as news, weather, exchange rates, stock prices, etc., without executing traditional searching steps including opening a web browser, inputting key words, etc. As a result, a user can watch TV and receive the latest information via the widget window at the same time.

Please refer to FIG. 1A, which is a schematic diagram of a TV 10 displaying a widget window according to the prior art. In FIG. 1A, the TV 10 preferably displays a video signal corresponding to TV programs in an upper part of a screen thereof, and displays a selection menu 100 of widgets in a lower part of the screen. The selection menu 100 is utilized for displaying various function options of the widgets to be selected by the user, such as weather, news, stock prices, exchange rates, etc. For example, when the user selects one of the function options via a remote control 12, the TV 10 displays detailed content 102 corresponding to the selected function option in a partial area of the upper part screen previously utilized for displaying the video signal, as illustrated in FIG. 1B. In other words, without proper allocation, the widget window would cover the original TV program content, thus upsetting the user.

Therefore, how to allocate a display area of the TV to simultaneously display the widget window and the video signal without sacrificing viewing quality has been a major objective of the industry.

### SUMMARY OF THE INVENTION

It is therefore a primary objective of the claimed invention to provide an electronic device and method for simultaneously displaying a widget window and a video signal in a display device.

The present invention discloses an electronic device for simultaneously displaying a widget window and a video signal in a display device. The electronic device includes a dividing unit for dividing a display area of the display device into a major display area and a minor display area, a first display unit for scaling the video signal to completely display the video signal in the major display area, and a second display unit for displaying the widget window in the minor display area.

The present invention further discloses a method for simultaneously displaying a widget window and a video signal in a display device. The method includes dividing a display area of the display device into a major display area and a minor display area, scaling the video signal to completely display the video signal in the major display area, and displaying the widget window in the minor display area.

The present invention further discloses an image processor for a display device. The image processor is utilized for simultaneously displaying a video signal and an internet video signal in a widget display mode of the display device, and comprises a first display unit for receiving the video signal and displaying the video signal in a major display area of the display device, and a second display unit for receiving the internet video signal from the internet and displaying the internet video signal in a minor display area of the display area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are schematic diagrams of a TV displaying a widget window according to the prior art.

FIG. 2A is a schematic diagram of a display device according to an embodiment of the present invention.

FIG. 2B is a schematic diagram of an electronic device according to an embodiment of the present invention.

FIG. 3A to FIG. 3D are schematic diagrams of divided display areas according to embodiments of the present invention.

FIG. 4A is a schematic diagram of the electronic device according to an alternative embodiment of the present invention shown in FIG. 2B.

FIG. 4B and FIG. 4C are schematic diagrams of overlap areas according to an embodiment of the present invention.

FIG. 5 is a schematic diagram of a process according to an embodiment of the present invention.

FIG. 6A is a schematic diagram of a display device according to an embodiment of the present invention.

FIG. 6B is a schematic diagram of an image processor of the display device shown in FIG. 6A.

FIG. 7 is a schematic diagram of a process according to an embodiment of the present invention.

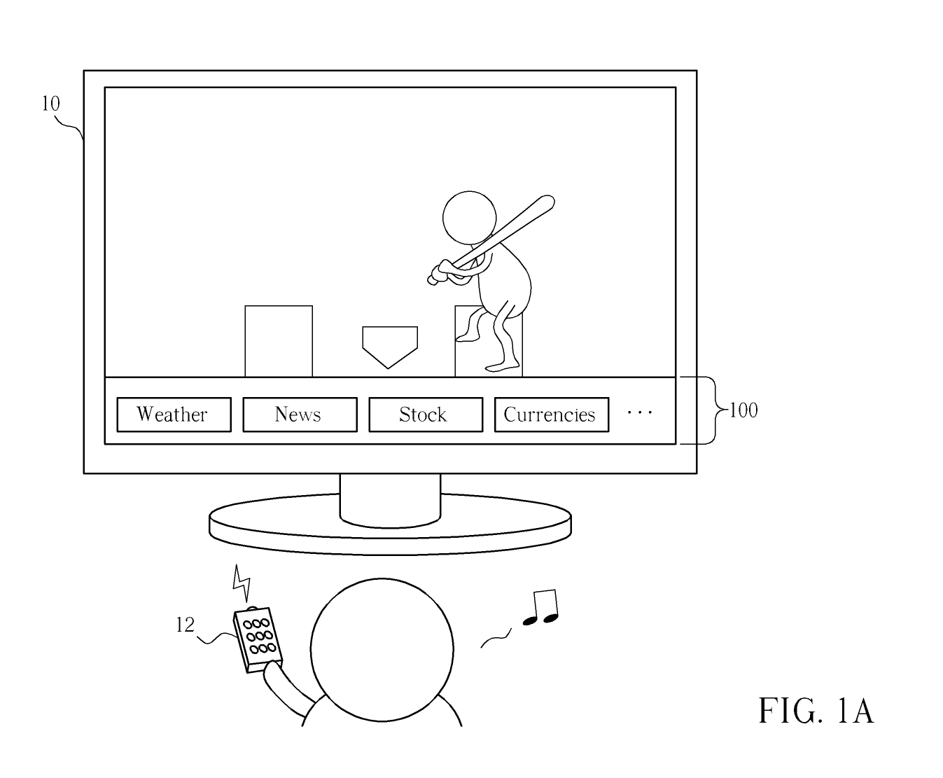

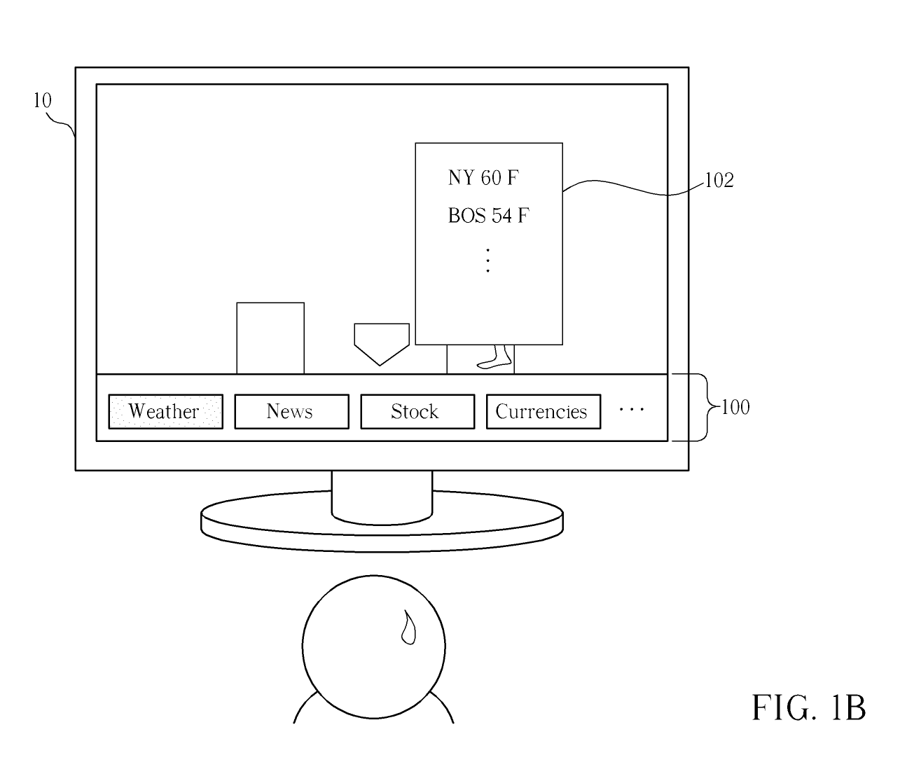

### DETAILED DESCRIPTION

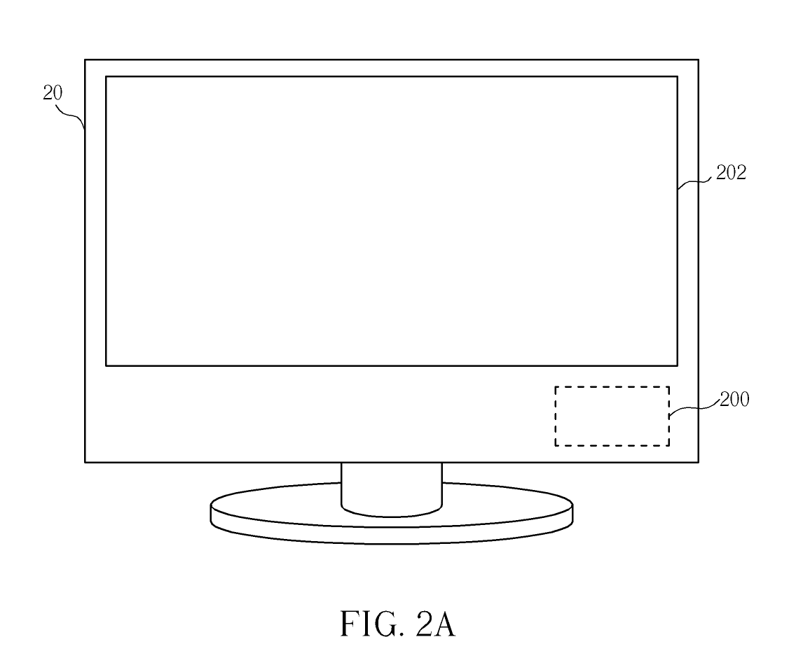

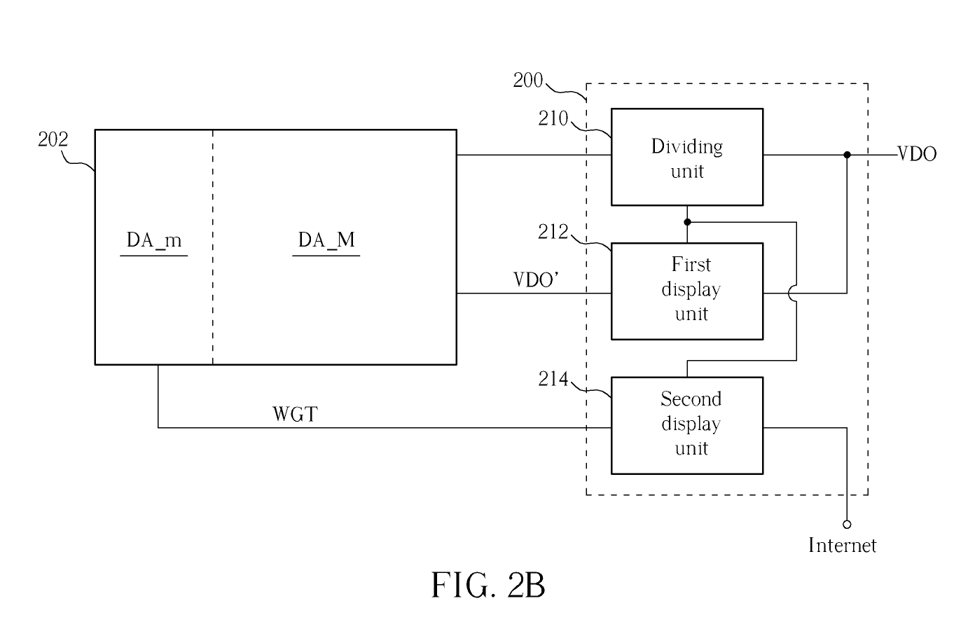

Please refer to FIG. 2A, which is a schematic diagram of a display device 20 according to an embodiment of the present invention. The display device 20 includes an electronic device 200 for controlling the display device 20, such that the display device 20 can simultaneously display a widget window and a video signal. Please continue to refer to FIG. 2B, which is a schematic diagram of the electronic device 200. The electronic device 200 includes a dividing unit 210, a first display unit 212 and a second display unit 214. The dividing unit 210 is utilized for dividing a display area 202 of the display device 20 into a major display area DA_M and a minor display area DA_m. The first display unit 212 is utilized for scaling a video signal VDO received by the display device 20 according to a dividing result of the dividing unit 210, to completely display the video signal VDO in the major display area DA_M. The second display unit 214 is utilized for displaying the widget window WGT in the minor display area DA_m according to the dividing result of the dividing unit 210.

In short, according to the present invention, the display area 202 of the display device 20 is divided into the major display area DA_M and the minor display area DA_m respectively utilized for displaying the video signal VDO and the widget window WGT. In addition, the video signal VDO is scaled to match the size of the major display area DA_M, such that a scaled video signal VDO′ can be completely displayed in the major display area DA_M. As a result, the video signal VDO and the widget window WGT are independently and completely displayed in different areas of the display area 202. That is, the widget window WGT no longer overlaps the video signal VDO, leading to an improvement of viewing quality compared to the prior art.

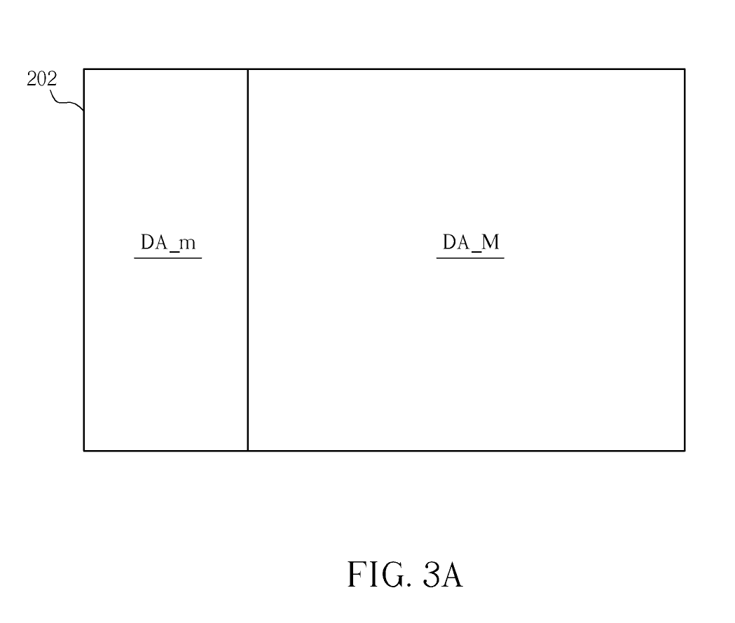

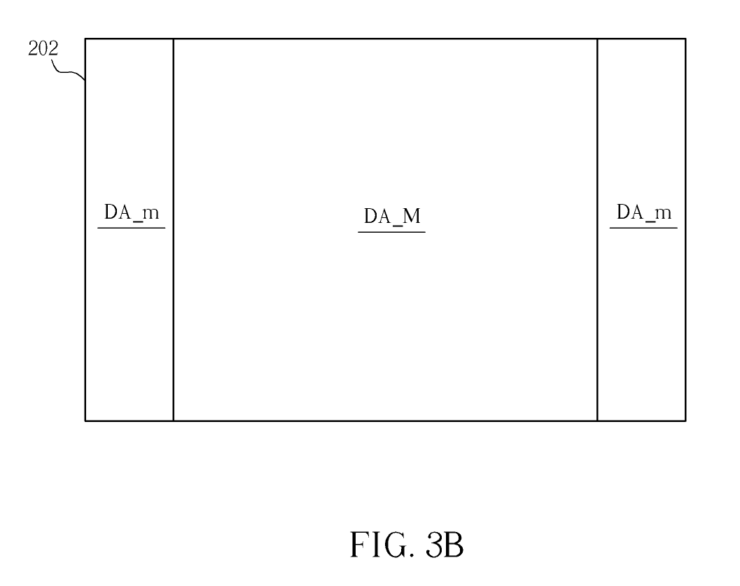

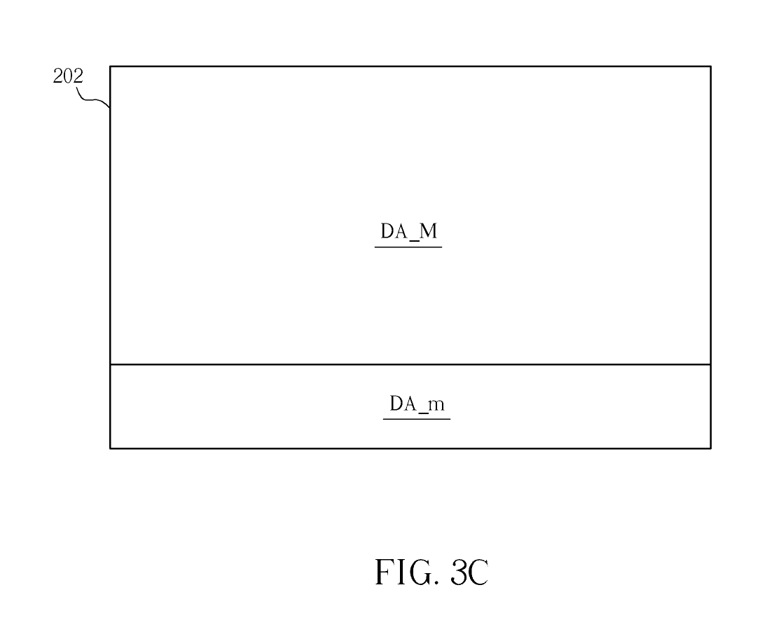

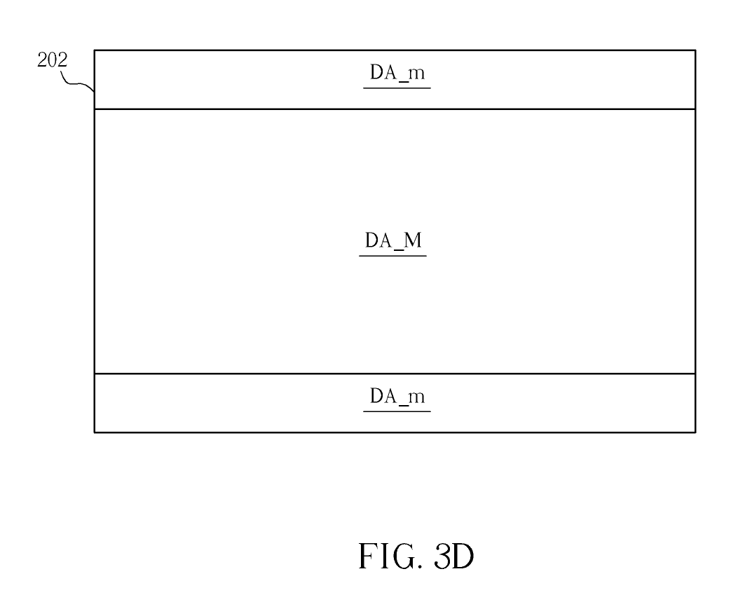

For more details about dividing operations, please continue to refer to FIG. 3A, which is a schematic diagram of the divided display area 202 according to an embodiment of the present invention. In FIG. 3A, the dividing unit 210 horizontally divides the display area 202 into a right part and a left part as the major display area DA_M and the minor display area MD_m respectively. Certainly, those skilled in the art can switch the positions of the major display area DA_M and the minor display area DA_m, i.e. the major display area DA_M can be allocated to the left side of the display area 202, and the minor display area DA_m can be allocated to the right side thereof. Note that the dividing unit 210 can further be utilized for dividing the display area 202 based upon an aspect ratio of the video signal VDO and the size of the display area 202 to simplify the process of the first display unit 212 scaling the size of the video signal VDO. For example, if the display device 20 is a wide-screen monitor comprising 1366×768 pixels according to a 16:9 aspect ratio, and the video signal VDO includes color intensity information of 1024×768 pixels according to a 4:3 aspect ratio, the dividing unit 210 can directly assign 1024×768 of the 1366×768 pixels to be the major display area DA_M, and assign the remaining 256×768 pixels to be the minor display area DA_m. As a result, the video signal VDO can be directly displayed in the major display area DA_M without being compressed, extended, etc., so as to simplify the signal processing process in the display device 20.

Similarly, the dividing unit 210 further can assign a left side and a right side of the display area 202 to be the minor display area DA_m, and assign a middle to be the major display area DA_M, as illustrated in FIG. 3B. Certainly, the dividing unit 210 can divide the display area 202 shown in FIG. 3B according to the aspect ratio of the video signal VDO and the size of the display area 202. For example, if the display device 20 is the wide-screen monitor comprising 1366×768 pixels according to the 16:9 aspect ratio, and the video signal VDO includes color intensity information of 1024×768 pixels according to the 4:3 aspect ratio, the dividing unit 210 can assign 1024×768 pixels in the middle of the display area 202 to be the major display area DA_M, and assign two sides, each including 128×768 pixels, to be the minor display area DA_m, so as to skip the compression/extension operation performed by the first display unit 212.

Other than dividing along the horizontal direction, the dividing unit 210 can divide the display area 202 into the major display area DA_M and the minor display area DA_m along the vertical direction as well. That is, an upper side or a lower side of the display area 202 is assigned to be the major display area DA_M, and another side is assigned to be the minor display area DA_m, as illustrated in FIG. 3C. Furthermore, the dividing unit 210 can assign an upper side and a lower side of the display area 202 to be the minor display area DA_m, and assigns a middle to be the major display area DA_M, as illustrated in FIG. 3D.

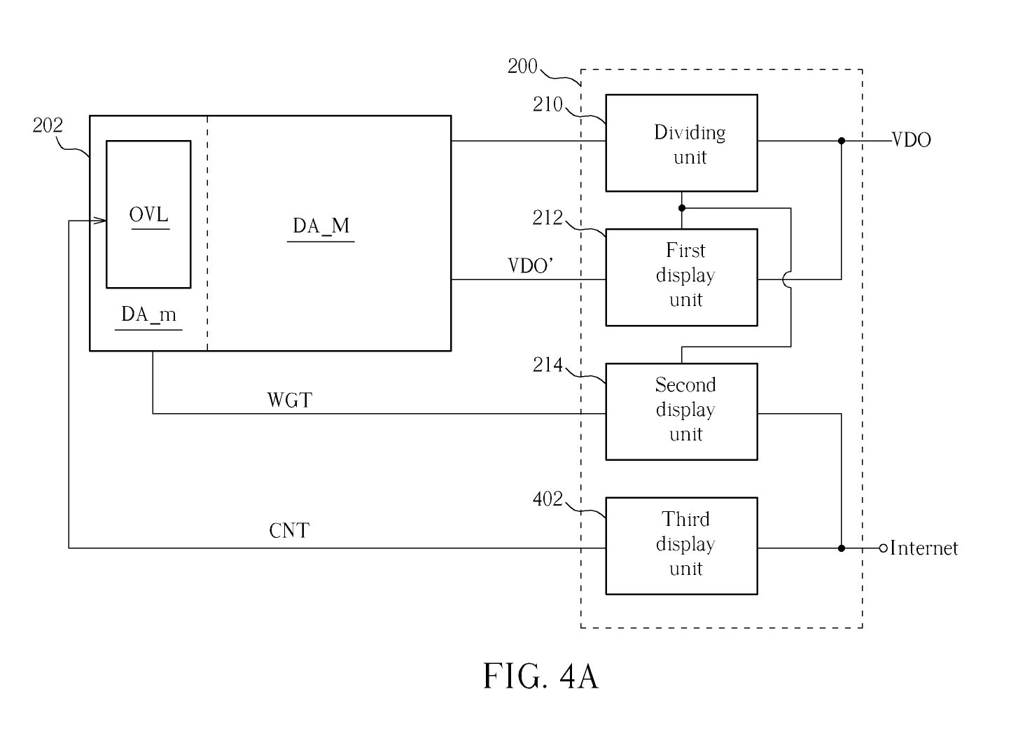

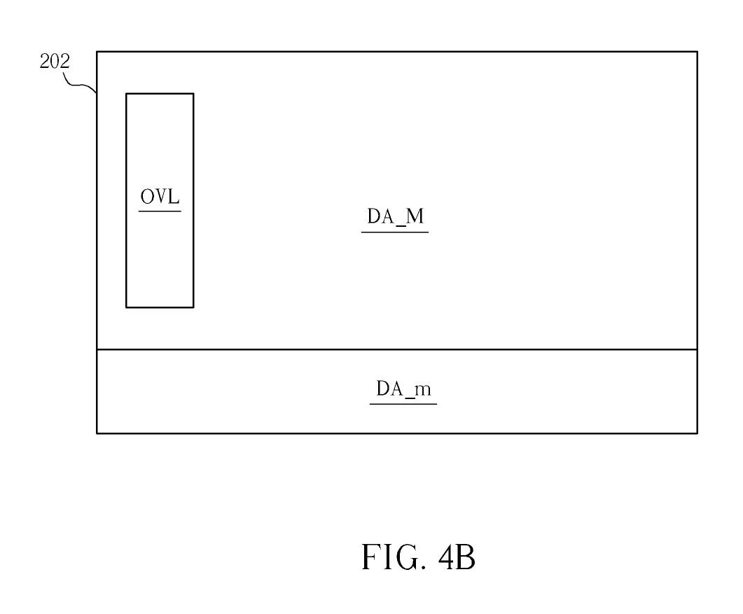

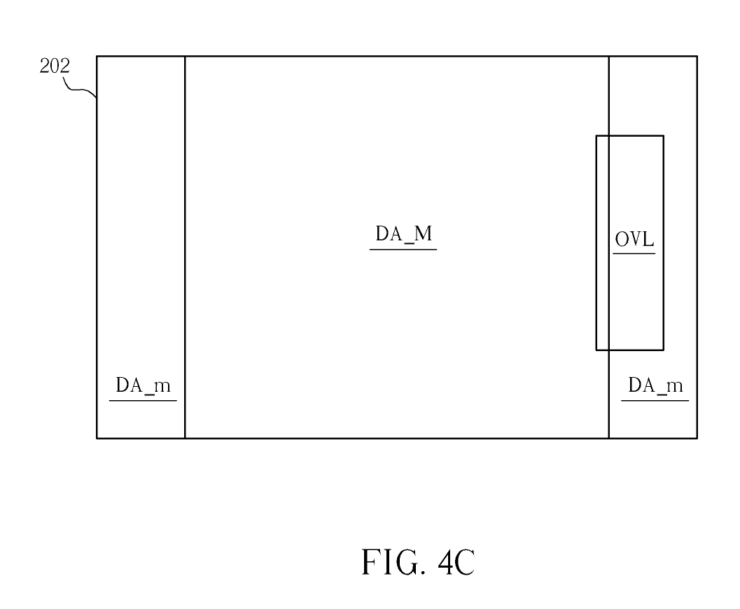

Note that, once the user selects one of functions provided by the widgets, the display device 20 has to download detailed content CNT corresponding to the selected function from the Internet, and display the detailed content CNT in the display area 202, as illustrated in FIG. 4A. For that reason, the electronic device 200 further includes a third display unit 402 for setting an overlap area OVL in the display area 202, to display the detailed content CNT of the selected widget. The third display unit 402 can allocate the overlap area OVL in different positions based upon practical requirements. For example, in FIG. 4A, the overlap area OVL is positioned in the minor display area DA_m to avoid overlapping with the video signal VDO. However, in specific applications (e.g. FIG. 3C), the overlap area OVL is preferably allocated in the major display area DA_M. Accordingly, the third display unit 402 can set the overlap area OVL to be located within the major display area DA_M, as illustrated in FIG. 4B. In addition, the overlap area OVL probably overlaps the major display area DA_M and the minor display area DA_m at the same time, as illustrated in FIG. 4C. Therefore, maintaining a completely-displayed video signal VDO is the main concern when allocating the overlap area OVL, and the allocation of the overlap area OVL highly depends on the practical dividing result of the display area 202. That is, the best position for the overlap area OVL in one case does not stand in others.

Certainly, the user may desire to watch the TV program only, and may want to disable the widget window WGT. For that reason, the display device 20 can further determine whether to activate the electronic device 200 according to a control signal indicating activation timing. In general, the control signal can be generated by:

(1) the display device 20 when powered on;

(2) a remote control corresponding to the display device 20; or

(3) a keypad of the display device 20.

In detail, in case (1), the display device 20 is pre-configured with an auto-display parameter. Whenever the display device 20 is powered on, the auto-display parameter is loaded to determine whether or not to simultaneously display the widget window WGT and the video signal VDO. In case (2), the remote control can be a TV remote control capable of activating the widget window WGT. In case (3), the keypad is an option of a selection menu built into the display device 20. That is other than traditional functions like color adjustment, brightness adjustment, etc., the selection menu further can be utilized for determining whether to display the widget window WGT. Note that the remote control and the selection menu can be utilized for modifying the auto-display parameter of the display device 20 as well, to match various requirements from the user.

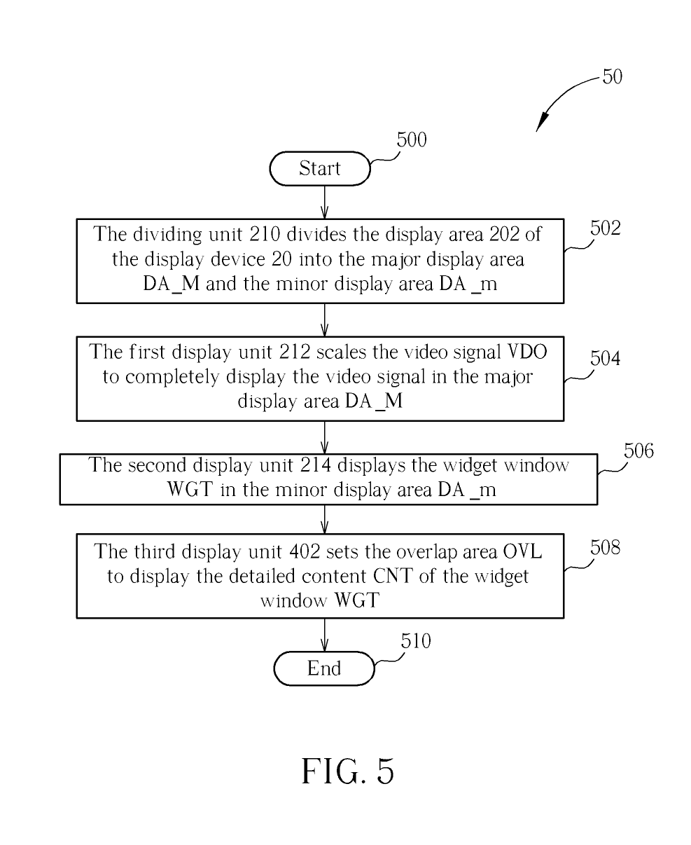

Operations of the electronic device 200 can be summarized into a process 50, as illustrated in FIG. 5. The process 50 includes the following steps:

Step 500: Start.

Step 502: The dividing unit 210 divides the display area 202 of the display device 20 into the major display area DA_M and the minor display area DA_m.

Step 504: The first display unit 212 scales the video signal VDO to completely display the video signal in the major display area DA_M.

Step 506: The second display unit 214 displays the widget window WGT in the minor display area DA_m.

Step 508: The third display unit 402 sets the overlap area OVL to display the detailed content CNT of the widget window WGT.

Step 510: End.

Detailed description of the process 50 can be referred in the above and is not further narrated herein.

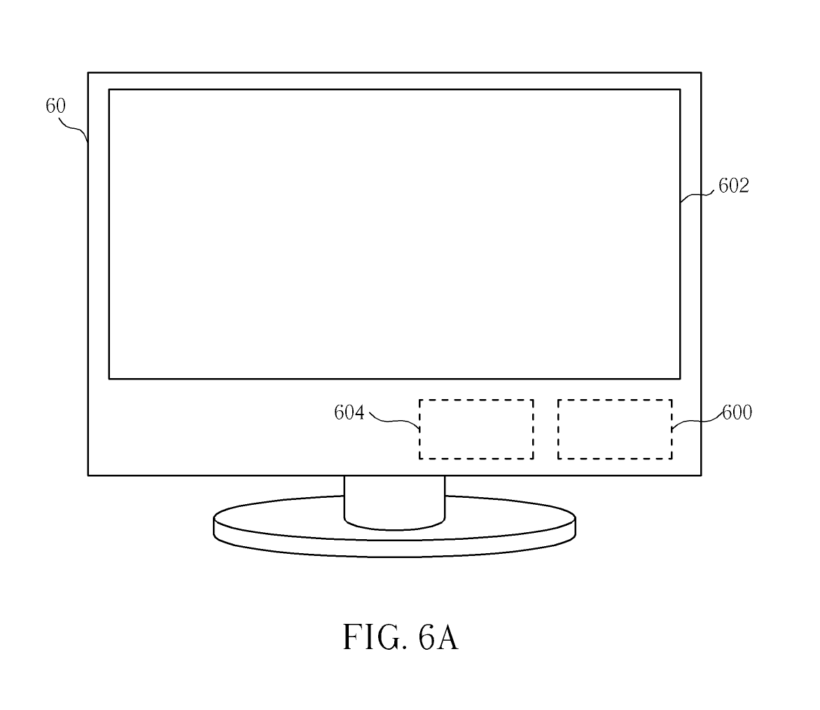

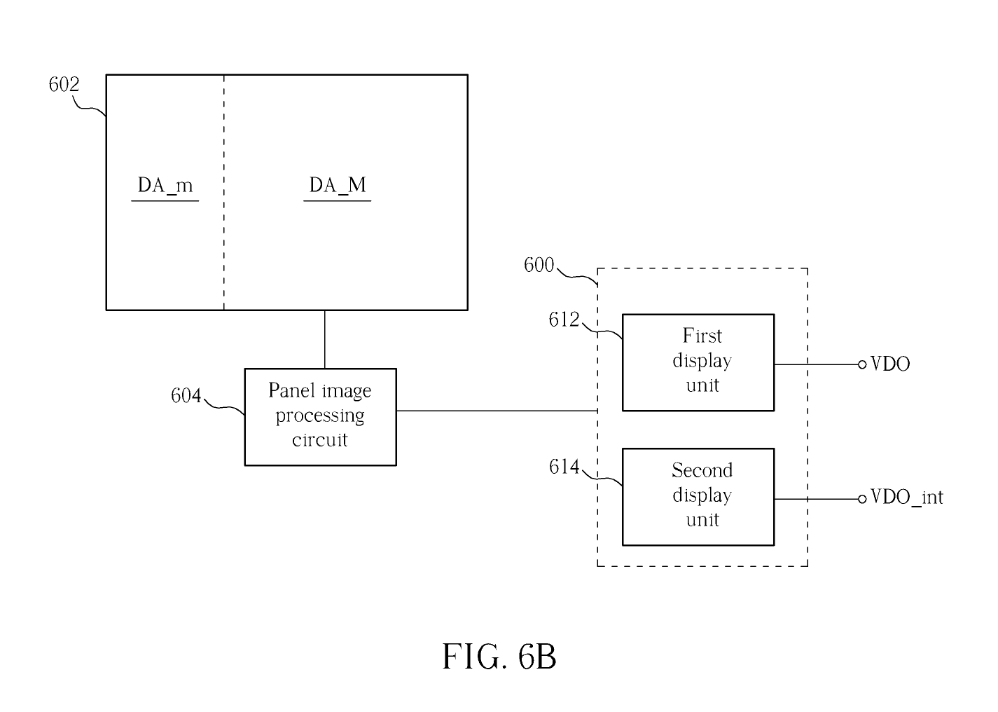

In addition to the display device 20, the present invention further discloses a display device 60, as illustrated in FIG. 6A. The display device 60 is similar to the display device 20, and can be operated in a widget display mode as well. The display device 60 includes an image processor 600, a display area 602 and a panel image processing circuit 604. Similarly, in the widget display mode, the display device 60 can divide the display area 602 into a major display area DA_M and a minor display area DA_m, as in FIG. 2B, FIG. 3B, FIG. 3C, FIG. 3D, FIG. 4B and FIG. 4C. More specifically, the image processor 600 is pre-configured with a dividing mode as in FIG. 2B, FIG. 3B and FIG. 3C. Once the user presses a specific keypad of a remote control corresponding to the display device 60, the display device 60 enters the widget display mode.

In detail, please refer to FIG. 6B, which is a schematic diagram of the image processor 600. The image processor 600 includes a first display unit 612 and a second display unit 614. Once the display device 60 enters the widget display mode, the first display unit 612 receives a video signal VDO and displays the video signal VDO in the major display area DA_M. Meanwhile, the second display unit 614 receives a video signal VDO_int from the Internet, and displays the video signal VDO_int in the minor display area DA_m. Next, the image processor 600 transfers the video signals VDO, VDO_int to the panel image processing circuit 604. Finally, the panel image processing circuit 604 converts the video signals VDO, VDO_int into corresponding driving signals, to respectively display the video signals VDO, VDO_int in the major display area DA_M and the minor display area DA_m.

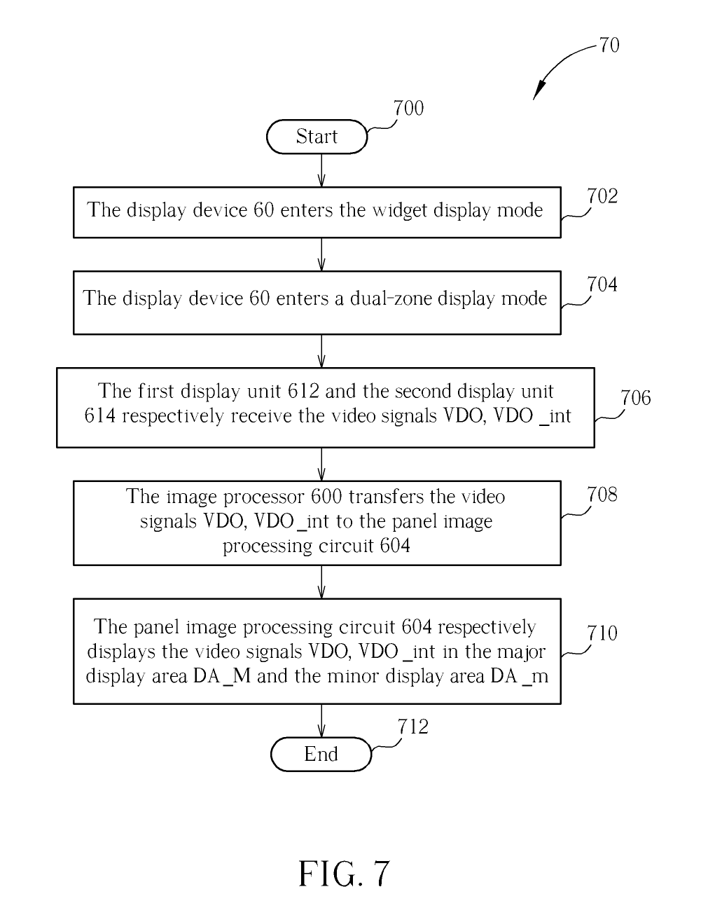

Operations of the electronic device 600 can be summarized into a process 70, as illustrated in FIG. 7. The process 70 includes the following steps:

Step 700: Start.

Step 702: The display device 60 enters the widget display mode.

Step 704: The display device 60 enters a dual-zone display mode

Step 706: The first display unit 612 and the second display unit 614 respectively receive the video signals VDO, VDO_int.

Step 708: The image processor 600 transfers the video signals VDO, VDO_int to the panel image processing circuit 604.

Step 710: The panel image processing circuit 604 respectively displays the video signals VDO, VDO_int in the major display area DA_M and the minor display area DA_m.

Step 712: End.

Detailed description of the process 70 can be referred in the above and is not further narrated herein.

In the prior art, if the user activates the widget window when watching TV, the detailed content 102 of the widget window would overlap the original TV program, and upset the user. In comparison, the present invention divides the display area 202 of the display device 200 into the major display area DA_M and the minor display area DA_m, to respectively display the video signal VDO and the widget window WGT in different display zones . In such a situation, the display device 200 can simultaneously display the widget window WGT and the video signal VDO without sacrificing viewing quality.

To sum up, the present invention respectively displays the widget window and the video signal in different display zones by dividing the display area, to prevent the original video content from being covered by the widget window.

Those skilled in the art will readily observe that numerous modifications and alterations of the device and method may be made while retaining the teachings of the invention.

What is claimed is:

1. An electronic device for simultaneously displaying a widget window and a video signal in a display device comprising:
a dividing unit, for dividing a display area of the display device into a major display area and a minor display area;
a first display unit, for scaling the video signal to completely display the video signal in the major display area; and
a second display unit, for displaying the widget window in the minor display area.

2. The electronic device of claim 1, wherein the dividing unit divides the display area of the display device into the major display area and the minor display area along a horizontal direction.

3. The electronic device of claim 2, wherein the dividing unit assigns one of a right side and a left side of the display area to be the major display area, and assigns the other side to be the minor display area.

4. The electronic device of claim 2, wherein the dividing unit assigns a right side and a left side of the display area to be the minor display area, and assigns a middle to be the major display area.

5. The electronic device of claim 1, wherein the dividing unit divides the display area of the display device into the major display area and the minor display area along a vertical direction.

6. The electronic device of claim 5, wherein the dividing unit assigns one of an upper side and a lower side of the display area to be the major display area, and assigns the other side to be the minor display area.

7. The electronic device of claim 5, wherein the dividing unit assigns an upper side and a lower side of the display area to be the minor display area, and assigns a middle to be the major display area.

8. The electronic device of claim 1 further comprising a third display unit, for setting an overlap area to display details of the widget window.

9. The electronic device of claim 8, wherein the overlap area overlaps the major display area.

10. The electronic device of claim 8, wherein the overlap area overlaps the minor display area.

11. The electronic device of claim 8, wherein the overlap area overlaps a portion of the major display area and a portion of the minor display area.

12. The electronic device of claim 1, wherein the dividing unit divides the display area of the display device into the major display area and the minor display area according to a control signal.

13. The electronic device of claim 12, wherein the control signal is generated when the display device is powered on.

14. The electronic device of claim 12, wherein the control signal is generated by a remote control corresponding to the display device.

15. The electronic device of claim 12, wherein the control signal is generated by selecting an option of the display device.

16. A method for simultaneously displaying a widget window and a video signal in a display device comprising:
dividing a display area of the display device into a major display area and a minor display area;
scaling the video signal to completely display the video signal in the major display area; and
displaying the widget window in the minor display area.

17. The method of claim 16, wherein the step of dividing the display area of the display device into the major display area and the minor display area is dividing the display area of the display device into the major display area and the minor display area along a horizontal direction.

18. The method of claim 17, wherein the step of dividing the display area of the display device into the major display area and the minor display area along the horizontal direction comprises:
assigning one of a right side and a left side of the display area to be the major display area; and
assigning the other side to be the minor display area.

19. The method of claim 17, wherein the step of dividing the display area of the display device into the major display area and the minor display area along the horizontal direction comprises:
assigning a right side and a left side of the display area to be the minor display area; and
assigning a middle to be the major display area.

20. The method of claim 16, wherein the step of dividing the display area of the display device into the major display area and the minor display area is dividing the display area of the display device into the major display area and the minor display area along a vertical direction.

21. The method of claim 20, wherein the step of dividing the display area of the display device into the major display area and the minor display area along the vertical direction comprises:
assigning one of an upper side and a lower side of the display area to be the major display area; and
assigning the other side to be the minor display area.

22. The method of claim 20, wherein the step of dividing the display area of the display device into the major display area and the minor display area along the vertical direction comprises:
assigning an upper side and a lower side of the display area to be the minor display area; and
assigning a middle to be the major display area.

23. The method of claim 16 further comprising setting an overlap area for displaying details of the widget window.

24. The method of claim 23, wherein the overlap area overlaps the major display area.

25. The method of claim 23, wherein the overlap area overlaps the minor display area.

26. The method of claim 23, wherein the overlap area overlaps a portion of the major display area and a portion of the minor display area.

27. The method of claim 16, wherein the step of dividing the display area of the display device into the major display area and the minor display area is dividing the display area into the major display area and the minor display area according to a control signal.

28. The method of claim 27, wherein the control signal is generated when the display device is powered on.

29. The method of claim 27, wherein the control signal is generated by a remote control corresponding to the display device.

30. The method of claim 27, wherein the control signal is generated by selecting an option of the display device.

31. An image processor in a display device, for simultaneously displaying a video signal and an internet video signal in a widget display mode, the image processor comprising:
a first display unit, for receiving the video signal and displaying the video signal on a major display area of the display device; and
a second display unit, for receiving the internet video signal from the internet and displaying the internet video signal on a minor display area of the display device.
